(19) United States
(12) Patent Application Publication
(10) Pub. No.: US 2013/0084030 A1
(43) Pub. Date: Apr. 4, 2013

(54) DISPOSABLE PLUG AND SENSOR FITTINGS FOR BIOREACTOR BAGS

(71) Applicants: Clinton C. Staheli, Brigham City, UT (US); Heather L. Kramer, Nibley, UT (US); Patrick L. Draper, Smithfield, UT (US)

(72) Inventors: Clinton C. Staheli, Brigham City, UT (US); Heather L. Kramer, Nibley, UT (US); Patrick L. Draper, Smithfield, UT (US)

(73) Assignee: HyClone Laboratories, Inc., Logan, UT (US)

(21) Appl. No.: 13/251,828

(22) Filed: Oct. 3, 2011

(51) Int. Cl. B65D 33/00; F16L 55/11; B23P 11/00

(52) U.S. Cl. 383/105; 137/15.01; 138/89

(57) ABSTRACT

A port fitting for use with a barbed fluid connector includes a plug having a first end and an opposing second end with a guide outwardly projecting from the second end. An O-ring is disposed on and encircling the plug. A pair of elongated arms project alongside the length of the plug. Each arm has a first end secured to the first end of the plug and an opposing second end that is freely disposed so that the arms can be flexed by manipulation of the second end. Each arm has a catch that inwardly projects toward to the guide. In one embodiment the guide terminates at an end wall and a channel extends through the plug and guide to the end wall. An optical sensor is mounted on the end wall.

### CROSS-REFERENCE TO RELATED APPLICATIONS

Not applicable.

### BACKGROUND OF THE INVENTION

1. The Field of the Invention

The present invention relates to plug fittings and sensor fittings usable with barbed ports, such as those found on bioreactor bags.

2. The Relevant Technology

Barbed fluid ports, which are tubular ports having a frustoconical tip, are commonly used on bioreactor bags and other types of bags and containers to enable an easy fluid coupling with the bag or container. When the barbed fluid ports are not in use, the ports are commonly plugged so that fluid cannot leak out and so that the compartment of the container and any fluid therein is not contaminated.

Traditionally, barbed fluid ports have been plugged and sealed by attaching a short length of flexible tubing over the barbed port and inserting a barbed plug or other fitting within the opposing free end of the tube. The flexible tubing creates a seal against the barbed feature of the port and the plug. Another common method for sealing a barbed fluid port closed is to press a flexible, annular cap over the exterior of the barbed port. The cap covers and engages the barb to form a sealed engagement.

Although conventional plug systems have been effective, they have some shortcomings. For example, because conventional plug systems operate by passing over and forming a sealed engagement with the barb, conventional plug systems can be difficult to attach and even more difficult to remove. This is because the barb on the fluid port can aggressively engage the plug system to restrict removal of the plug.

Furthermore, when conventional barbed fluid ports are capped, they form a dead space within the port where fluid can stagnate. This is particularly problematic on bioreactor bags where it is necessary that the cell culture within the bag be continuously and uniformly mixed and aerated to keep the cells alive. Using closed tubes extending from the fluid port to act as the plug can further exasperate this problem of forming a dead space.

Various sensors, such as temperate sensors, pH sensors, and CO₂ sensors are also used with bioreactors to measure properties of the solution therein. Historically, such sensors were designed to project directly into the bioreactor container so as to contact the solution. In this application, however, it was necessary to remove and sterilize the sensors between each separate use.

Under current technology, however, a transparent housing can be sealed within a barbed fluid port mounted on a bioreactor bag so that the housing is in fluid communication with the cell culture or other solution therein. A fluorescent sensor is disposed on the end of the transparent housing so as to be in direct contact with the fluid. The fluorescence of the fluorescent sensor changes based on the properties of the fluid. A fiber optic cable disposed within the housing can shine a light on the fluorescent sensor through the housing and then carry a reflective signal from the fluorescent sensor back to an apparatus that can then determine from the signal the desired properties of the fluid.

Because the fiber optic cable does not directly contact the fluid, no sterilization of the cable is required between different uses. The transparent housing, however, is difficult to attach and remove from the fluid port and provides limited variability in the attachment of different sizes, types, or kinds of fiber optic cables.

Accordingly, what is needed in the art are plug fittings and sensor fittings that solve one or more of the above problems and other shortcomings that are currently known in the art.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 is a perspective view of a bioreactor system which includes a bag assembly disposed on a rocker;

FIG. 2 is an exploded view of the bag assembly shown in FIG. 1;

FIG. 3 is a perspective view of a port assembly of the bag assembly shown in FIG. 1;

FIG. 4 is a front perspective view of a plug fitting shown in FIG. 2;

FIG. 5 is an elevated side view of the plug fitting shown in FIG. 4;

FIG. 6 is a rear perspective view of the plug fitting shown in FIG. 4;

FIG. 7 is a perspective view of the plug fitting shown in FIG. 4 being received within a port of the port assembly;

FIG. 8 is an elevated side view of the plug fitting shown in FIG. 7 fully

received within the port and having a tie secured thereto;

FIG. 9 is a perspective view of a sensor fitting shown in FIG. 2;

FIG. 10 is an elevated side view of the sensor fitting shown in FIG. 9;

FIG. 11 is a cross sectional side view of the sensor fitting shown in FIG. 10;

FIG. 12 is a elevated side view of a fiber optic cable that can couple with the sensor fitting;

FIG. 13 is a perspective view of the sensor fitting partially received within one of the ports shown in FIG. 3; and

FIG. 14 is an elevated side view of the sensor fitting fully received within the port shown in FIG. 13 and having a tie secured thereto.

### DETAILED DESCRIPTION OF THE PREFERRED EMBODIMENTS

As used in the specification and appended claims, directional terms, such as “top,” “bottom,” “left,” “right,” “up,” “down,” “upper,” “lower,” “proximal,” “distal” and the like are used herein solely to indicate relative directions and are not otherwise intended to limit the scope of the invention or claims. Furthermore, multiple instances of an element may each include separate letters appended to the element number. For example, two instances of a particular element “20” may be labeled as “20A” and “20B”. In that case, the element label may be used without an appended letter (e.g., “20”) to generally refer to every instance of the element; while the element label will include an appended letter (e.g., “20A”) to refer to a specific instance of the element.

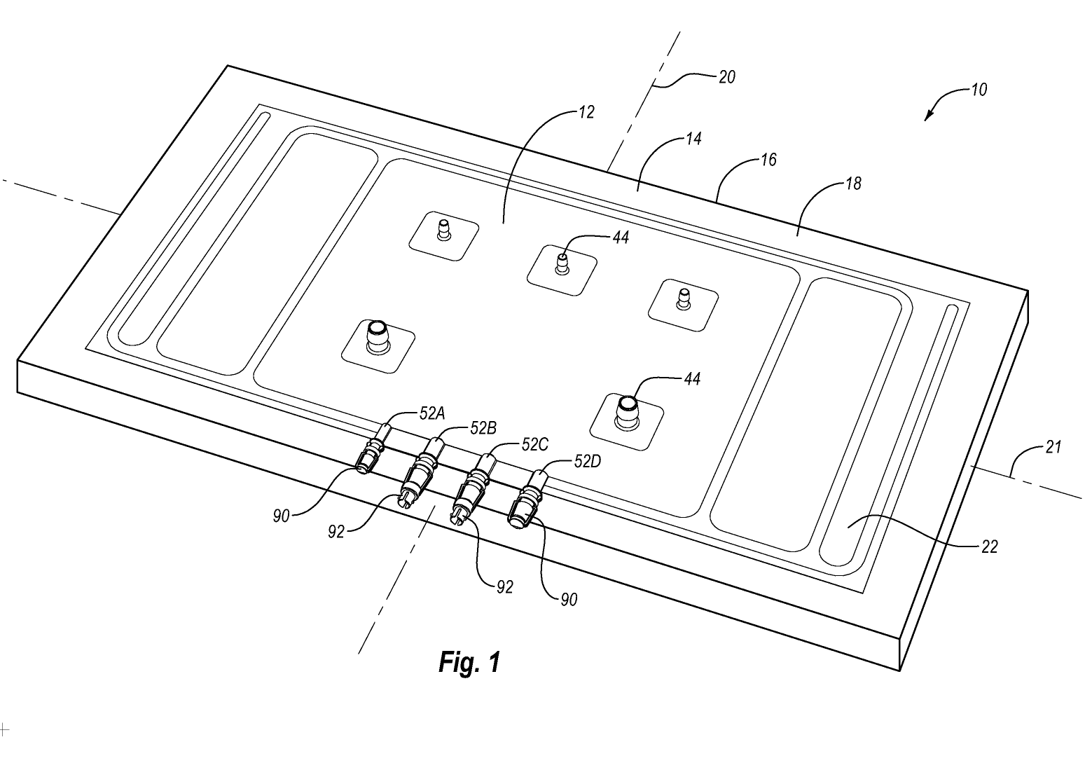

Depicted in FIG. 1 is one embodiment of an inventive bioreactor system 10 incorporating features of the present invention. Bioreactor system 10 includes a novel bioreactor bag assembly having novel port fittings coupled thereto. The port fittings can include plug fittings and sensor fittings. As will be discussed below in greater detail, it is appreciated that the plug fittings and sensor fittings need not only be used with a bioreactor bag but can also be used with other types of bags or containers where it is desired to plug a port and/or conduct sensing through a port.

As shown in FIG. 1, bioreactor system 10 comprises a bag assembly 12 mounted on a rocker 14. Rocker 14 comprises a platform 16 having a top surface 18 on which bag assembly 12 is disposed. Rocker 14 is configured to repeatedly rock or tilt platform 16 back and forth about a transverse axis 20, lateral axis 21 or some other axis so that fluid contained within bag assembly 12 is continuously mixed by wave motion. Where the fluid comprises a cell culture, this mixing helps to ensure that the fluid is homogenous for consistent feeding of the cells and helps to ensure uniform aeration. It is appreciated that rocker 14 can comprise any conventional type of bioreactor rocker. One example of a bioreactor rocker comprises the WAVE bioreactor available from GE Healthcare.

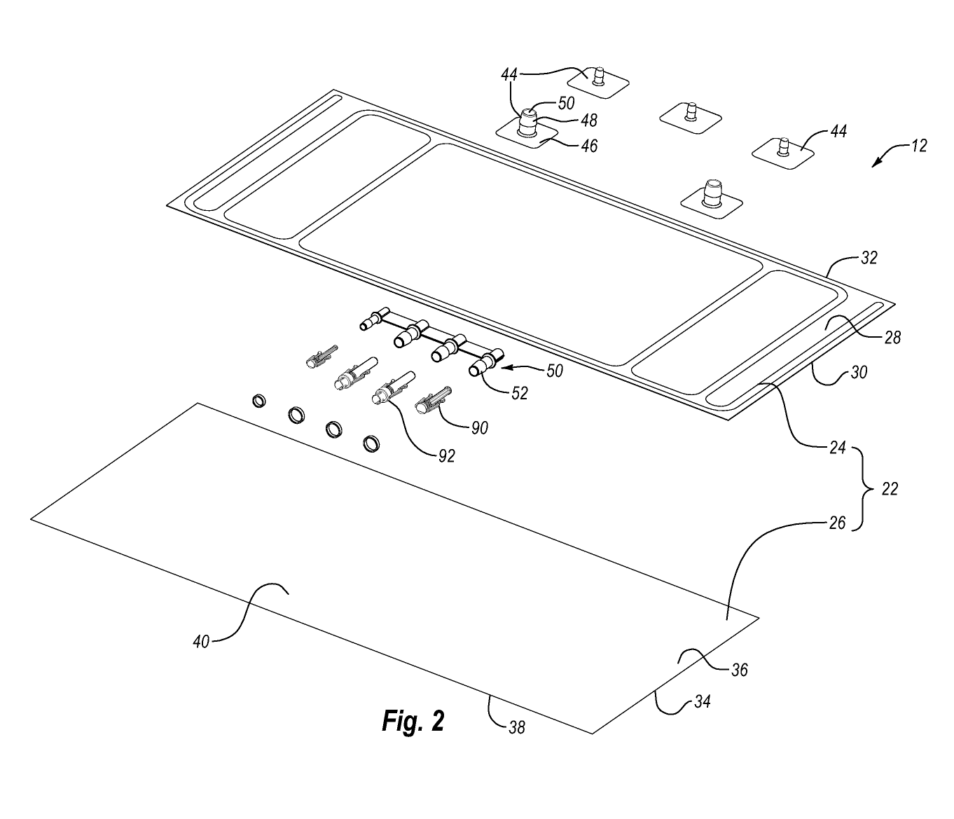

As depicted in FIG. 2, bag assembly 12 comprises a processing bag 22 having various ports coupled thereto. Specifically, processing bag 22 can comprises a top wall 24 that overlays an opposing bottom wall 26. Top wall 24 has an exterior surface 28 and an opposing interior surface 30 that both extend to a perimeter edge 32. Similarly, bottom wall 26 has an exterior surface 34 and opposing interior surface 36 that both extend to a perimeter edge 38. Each of walls 24 and 26 is comprised of a flexible polymeric sheet or film which typically has a thickness in a range between about 4 mil to about 15 mil with about 7 mil to about 14 mil being more common. Other thicknesses can also be used. During assembly, walls 26 and 28 are overlaid and perimeter edges 32 and 38 are secured together such as by welding, adhesive, or other conventional techniques. As a result, a compartment 40 is formed between walls 24 and 26 which can hold a fluid such as a cell culture or other fluid.

The depicted embodiment is a two-dimensional pillow-type bag. Other pillow- type bags can be formed by folding over a single sheet and then securing together the overlying perimeter edges. In yet another embodiment, a tubular film can be formed and cut to length. The overlying ends can then be secured together to form processing bag 22. Other methods of fabrication can also be used to produce other pillow-type bags. In still other embodiments, processing bag 22 can comprise a three dimensional bag such as is known in the art.

Processing bag 22 can be comprised of a flexible, water impermeable material such as a low-density polyethylene or other polymeric sheets. The material can be comprised of a single ply material or can comprise two or more layers which are either sealed together or separated to form a double wall container. Where the layers are sealed together, the material can comprise a laminated or extruded material. The laminated material comprises two or more separately formed layers that are subsequently secured together by an adhesive.

In one embodiment, processing bag 22 may be made from a material suitable for extrusion, casting, and/or blow molding. The extruded material may include a single integral sheet that comprises two or more layers of different materials that can be separated by a contact layer. All of the layers may be simultaneously co-extruded. One example of an extruded material that can be used in the present invention is the HyQ CX3-9 film available from HyClone Laboratories, Inc. out of Logan, Utah. The HyQ CX3-9 film is a three-layer, 9 mil cast film produced in a cGMP facility. The outer layer is a polyester elastomer coextruded with an ultra-low density polyethylene product contact layer. Another example of an extruded material that can be used in the present invention is the HyQ CX5-14 cast film also available from HyClone Laboratories, Inc. The HyQ CX5-14 cast film comprises a polyester elastomer outer layer, an ultra-low density polyethylene contact layer, and an EVOH barrier layer disposed therebetween. In still another example, a multi-web film produced from three independent webs of blown film can be used. The two inner webs are each a 4 mil monolayer polyethylene film (which is referred to by HyClone as the HyQ BM1 film) while the outer barrier web is a 5.5 mil thick 6-layer coextrusion film (which is referred to by HyClone as the HyQ BX6 film).

It is appreciated that processing bag 22 can be manufactured to have virtually any desired size, shape, and configuration. Generally, chamber 40 of processing bag 22 will have a volume in a range from 1 liter to 100 liters with from 2 liters to 40 liters and 5 liters to 20 liters being more common. Other desired volumes can also be used.

Continuing with FIG. 2, bag assembly 12 further comprises a plurality of spaced apart tube ports 44 coupled with top wall 24 of processing bag 22. Each tube port 44 comprises a flange 46 that is secured to top wall 24, typically on interior surface 30, and a barbed stem 48 outwardly projecting therefrom. Each barbed stem 48 has a channel 50 extending therethrough that communicates with compartment 40 of processing bag 22. Tube ports 44 can be used for delivering or withdrawing fluid and/or gas into or out of compartment 40 or can be used for other purposes common to reactors. It is appreciated that tube ports 44 can have different sizes and configurations and when not in use are sealed closed.

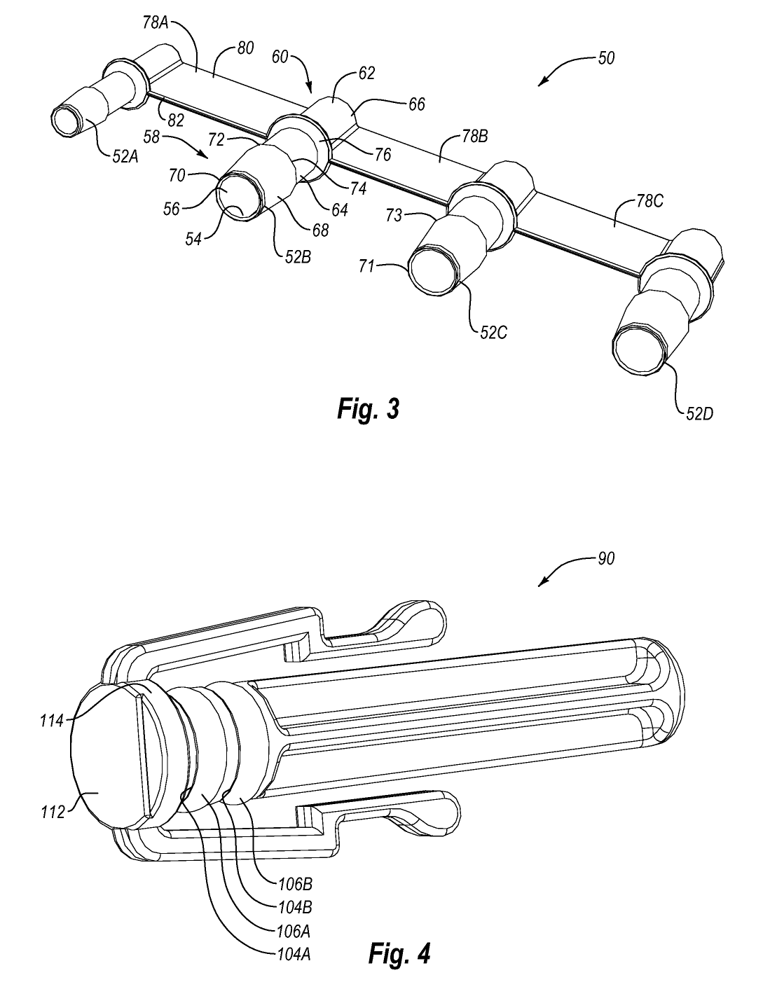

Bag assembly 12 further comprises a plurality of barbed ports that are secured between perimeter edges 32 and 38 of walls 24 and 26. In the embodiment depicted, a port assembly 50 is shown. As depicted in FIG. 3, port assembly 50 comprises a plurality of barbed ports 52A-D. Each port 52 has the same configuration that includes an interior surface 54 bounding a passageway 56 that longitudinally extends therethrough between a first end 58 and opposing second end 60. More specifically, each port 52 comprises a tubular stem 62 having a first end 64 and an opposing second end 66. An annular flange 76 encircles and radially outwardly extends from stem 62 at a location between opposing ends 64 and 66.

Ports 52 also include a tip 68 projecting from first end 64 of stem 62. Tip 68 has a frustoconical configuration that radially outwardly flares from a first end 70 to an opposing second end 72. First end 70 terminates at an annular end face 71 while second end terminates at an annular ridge 73. As perhaps best shown in FIG. 8, tip 68 further includes an annular shoulder 74 that inwardly projects from annular ridge 73 of tip 68 to first end 64 of stem 62. In one embodiment, each port 52 has a central longitudinal axis 53 extending therethrough and shoulder 74 is disposed normal to the axis 53.

Returning to FIG. 3, port assembly 50 further includes braces 78A-C that extends between adjacent ports 52A-D. Each brace 78 has a flat planar configuration with opposing sides 80 and 82. Specifically, each brace 78 spans between a pair of adjacent ports 52 and the opposing ends of braces 78 extend along a stem 62 from flange 76 to second end 60. Although four ports 52A-D are shown, it is appreciated that port assembly 50 can comprise 1, 3, 5 or more ports 52. Ports 52 can also have different sizes and different configurations. For example, port 52A is smaller than port 52B. Port assembly 50 is typically molded as a single integral unitary structure so that it is easy to attach port assembly 50 to processing bag 22.

To secure port assembly 50 to processing bag 22, braces 78 and adjacent second end 60 of ports 52 are placed between perimeter edges 32 and 38 of walls 24 and 26 (FIG. 2). Flanges 76 are used as a stop to help ensure proper placement. Walls 24 and 26 are then sealed against stems 62 and the opposing sides of braces 78 so that a liquid tight seal is formed between port assembly 50 and processing bag 22. This attachment can be accomplished through conventional welding techniques, adhesive, or the like. Once assembled, each passageway 56 extending through ports 52A-D communicates with compartment 40 of processing bag 22. In other embodiments, it is appreciated that ports 52A-D need not be coupled together by braces 78. Rather, separate and discrete ports 52 can be separately connected to processing bag 22.

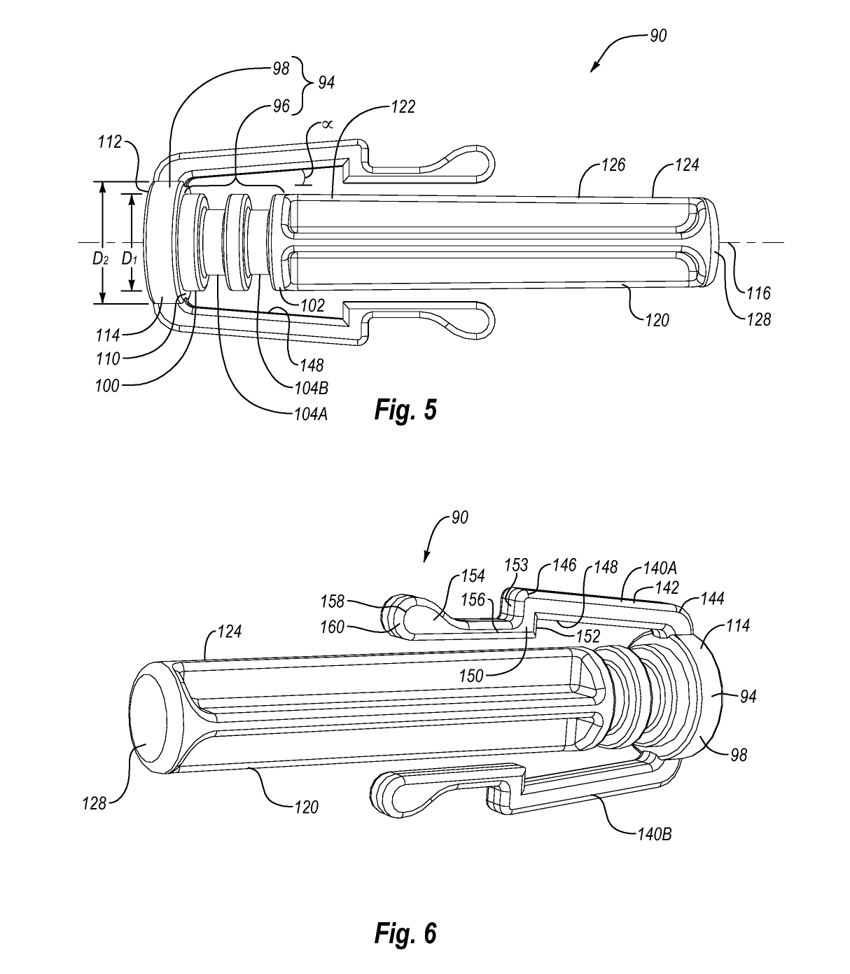

As depicted in FIG. 1, a port fitting is removeably coupled with each port 52A-D. Specifically, as depicted in FIG. 2, the port fittings are shown as comprising either a plug fitting 90 or a sensor fitting 92. Depicted in FIG. 4 is one embodiment of plug fitting 90. As depicted in FIG. 5, plug fitting 90 comprises a plug 94 that includes a stem 96 having an enlarged end cap 98 mounted thereon. Stem 96 has a substantially cylindrical configuration that extends from a first end 100 to opposing second end 102. Stem 96 has a maximum outer diameter D₁ and is sized so that it can be received within passageway 56 of ports 52 (FIG. 3). In one embodiment, diameter D₁ can be in a range between about 1 mm to about 20 mm with about 1 mm to about 15 mm or about 1 mm to about 7 mm being more common. Other dimensions can also be used.

A pair of spaced apart, annular seal glands 104A and 104B encircle and are recessed on stem 96. As depicted in FIG. 4, annular seals 106A and 106B can be disposed within seal glands 104A and 104B, respectively. Seals 106 can comprise an O-ring or other shaped annular seals.

Returning to FIG. 5, end cap 98 is disposed on first end 100 of stem 96 and is shown as having a circular transverse cross-section with a maximum diameter D₂ that is larger than diameter D₁. In alternative embodiments, end cap 98 need not be circular but can be polygonal or other configurations. End cap 98 is shown as has having an inside face 110, an outside face 112, and an annular side face 114 extending therebetween. End cap 98 is larger than first end 70 of port 52 (FIG. 3) and, as will be discussed below in greater detail, can function as a stop when fitting plug 90 is coupled with a port 52.

Port fitting 90 is shown as having a longitudinal axis 116 that centrally extends through plug 94. Projecting from second end 102 of stem 96 is a guide 120. Longitudinal axis 116 can also centrally extend through guide 120. Guide 120 has a first end 122 secured to second end 102 of stem 96 and has an opposing second end 124. An exterior surface 126 extends between ends 122 and 124. Exterior surface 126 of guide 120 can have a taper that inwardly radially constricts from first end 122 to second end 124 or can have a constant diameter along its length. Second end 124 terminates at end face 128 which is shown in FIG. 6 as being circular. To minimize material costs, however, the reminder of guide 120 extending between first end 122 and end face 128 has a substantially plus “+” shaped transverse cross-section. As will be discussed below, however, guide 120 in part functions as a guide for inserting plug 94 within passageway 56 of port 52 (FIG. 3) and as such the transverse cross section of guide 120 can be any desired configuration such as circular, elliptical, polygonal, irregular or the like as long as it can be received within passageway 56 of port 52. It is also appreciated that the transverse cross section of guide 120 can very along its length either continuously or at stages. However, guide 120 can also function to occupy the volume of passageway 56 within port 52 (FIG. 3) so as to minimize any dead space within port 52. As such, guide 120 can also have a configuration complementary to passageway 56.

Continuing with FIG. 6, plug fitting 90 further comprises a pair of arms 140A and 140B that project from side face 114 on opposing sides of end cap 98. Arms 140A and 140B having the same configuration. As such only Arm 140A will be discussed in detail herein with the understanding that the same discussion is also applicable to arm 140. Like elements between arms 140A and B will also be identified by like reference characters. Arm 140A comprises an elongated forearm 142 having a first end 144 that is secured with side face 114 of end cap 98 and an opposing second end 146. Forearm 142 projects in the direction toward second end 124 of guide 120 so that forearm 142 projects along the length of plug 94. Forearm 142 has an inside face 148 that can slope radially outward as it extends toward second end 146 at an angle a relative to longitudinal axis 116 (FIG. 5) in a range between 1° to about 10° with about 1° to about 5° being more common. Other angles can also be used. Forearm 142 can also be formed with a central longitudinal axis that projects at the same angle a relative to longitudinal axis 116.

Arm 140A also includes a catch 150 that inwardly projects from second end 146 of forearm 142 toward guide 120 or longitudinal axis 116. Catch 150 has an inside face 152 that can extend substantially perpendicular to longitudinal axis 116 and has an opposing outside shoulder 153 that inwardly projects toward guide 120 or longitudinal axis 116. Arm 140A also includes a back arm 154 having a first end 156 that connects to catch 150 and an opposing second end 158 that is freely disposed. Second end 158 can have an enlarged head 160 formed thereat to facilitate ease in griping arm 140A. Because arm 140A is only connected to plug 94 at first end 144 in a cantilever fashion, arm 140A is resiliently flexible and can be radially outwardly flexed by grasping second end 158 and pulling radially outward. By so doing, catch 150 can be flexed radially outward.

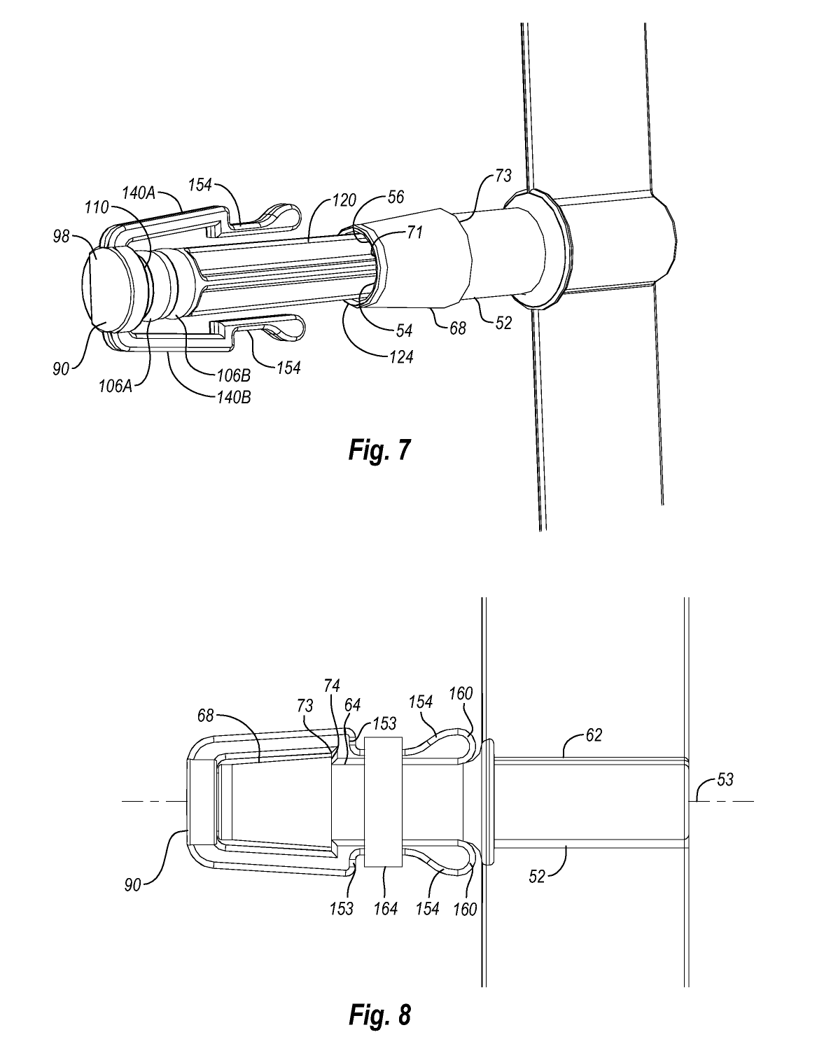

During use, as shown in FIG. 7, second end 124 of guide 120 is received within passageway 56 of barbed port 52. Any tapering of guide 120 facilitates ease of insertion. Next, guide 120 is advanced into passageway 56 so that stem 96 of plug 94 and related seals 106A and 106B are received within passageway 56. Plug 94 can be advanced until end face 71 of port 52 hit against inside face 110 of end cap 98. Stem 96 and seals 106 are sized so that seals 106 biases against interior surface 54 of port 52 and the exterior surface of stem 96 so that a liquid tight seal is formed between plug 94 and port 52, thereby sealing port 52 closed. The sealing of port 52 both prevents leaking of fluid from compartment 40 and prevents any outside contamination from reaching the fluid within compartment 40. It is appreciated that plug fitting 90 can be sized to be used with any sized barbed port.

In one embodiment, the combined length of stem 96 and guide 120 can be the same length or longer than the length of passageway 56 within port 52. In one embodiment, the combined length of stem 96 and guide 120 can be in a range between about 1 cm to about 12 cm with about 1 cm to about 7 cm and about 1 cm to about 5 cm being more common. Other lengths can also be used. As a result, stem 96 and guide 120 can occupy substantially all of the space within passageway 56, thereby preventing or minimizing any fluid from entering and stagnating within passageway 56. This is particularly important for cultures containing live cells or other fluids that must be uniformly mixed or aerated. Stem 96 and guide 120 thus help prevent the formation of a “dead leg” volume that communicates with compartment 40. It is appreciated that having end face 128 be circular and substantially the same diameter as passageway 56 helps prevent living cells from passing between end face 128 and interior surface 54 of port 52. To further help prevent cell from passing bay end face 128 another annular seal can be disposed at second end 124 of guide 120. Likewise, as previously mentioned, all of guide 120 can have a circular transverse cross section that more completely fills passageway 56. In other embodiments, the combined stem 96 and guide 120 need not extend the full length of passageway 56 to be helpful in minimizing dead fluid. For example, the combined stem 96 and guide 120 can have a length between 60% to 95% of the full length of passageway 56 or between 70% to 90% or 80% to 90% thereof.

As guide 120 and stem 98 are being received within passageway 56 of port 52, back arms 154 or a portion thereof of arms 140A and B ride against tip 68 of port 52. Due to the frustoconical configuration of tip 68, arms 140A and B radially outwardly flex. When catches 150 pass over annular ridge 73, arms 140A and B resiliently inwardly rebound or snap so that catches 150 pass behind or over shoulder 74, thereby locking plug fitting 90 onto barbed port 52 as shown in FIG. 8. To remove plug fitting 90 from port 52, back arms 154 of arms 140A and B are griped and manually flexed radially outward until catches 150 extend out beyond shoulder 74 and annular ridge 73. Plug fitting 90 is then free to be pulled out of channel 56 of port 52.

As shown in FIG. 8, to ensure that plug fitting 90 does not unintentionally get pulled out of port 52, a tie 164 can be encircled around stem 62 of port 52 so as to pass over back arms 154. Tie 164 can comprise a cable tie, hose clamp, crimp, or any other type of constricting structure. Tie 164 is placed in a groove formed between shoulders 153 and enlarged heads 160. Shoulders 153 and heads 160 help define the proper position for tie 164 and prevent tie 164 from sliding either forward or backward off of arms 140A and B and thus off of plug fitting 90. Tie 164 prevents outward flexing of arms 140A and B which thus acts as a second locking mechanism to prevent unwanted removal or loosening of plug fitting 90. This configuration thus adds additional security for high risk fluids such as sterile fluids, hazardous fluids or high value fluids. This double locking mechanism of plug fitting 90 also enable plug fitting 90 to be used in a pressurized system. For example, plug fitting 90 can be used where fluid pressures are in a range between about 5 KPa to about 500 KPa with about 5 KPa to about 50 KPa being more common. In contrast, conventional plugging systems may leak or get blow off under elevated pressures.

In addition to the benefits discussed above, as a result of its configuration, plug fitting 90 can be made of materials that are substantially more rigid than some conventional plugs. This can provide plug fitting 90 with added strength properties and enable it to be made out of a larger range of materials where such different material properties are desired. For example, plug fitting 90, except for seals 106, can be made of material having a durometer on a shore D scale in a range between about 30 to about 80 with about 60 to about 80 being more common. Softer materials or materials having other durometer ranges can also be used.

Traditionally, plug fitting 90, except for seals 106, will be made as a single, unitary, integral structure to which seals 106 can be attached. Plug fitting 90 can typically be made of materials such as polypropylene, copolyester, polyester, high-density polyethylene (HDPE), polycarbonate, polyvinylidene fluoride (PVDF), or polyethylene terephthalate (PET). Other materials can also be used.

In addition to different sizes, it is appreciate that plug fitting 90 can come in a variety of difference configurations. For example, plug fitting 90 can be formed with a single seal gland 104 and corresponding seal 106 or can be formed with three or more seal glands and corresponding seals. In yet other embodiments, seal glands 104 and seals 106 can be eliminated and stem 96 can be sized to produce a friction fit within port 52 so as to form a liquid tight sealed engagement therewith. Furthermore, in contrast to having two spaced apart arms 140A and B, plug fitting 90 can be formed with a single arm 140 or with three or more spaced apart arms. Arms 140 can also project from other surfaces on end cap 98 such as inside face 110 or outside face 112. In addition, end cap 98 can be eliminated and arms 140 can project out from the side of first end 100 of stem 96. Stem 96 could then be advanced until end face 71 of port 52 hits against first end 144 of arms 140A and B. Guide 120 functions to assist in the placement of plug fitting 90 but is not required to produce the liquid type seal. As such, in alternative embodiments guide 120 can be eliminated. Other alternative embodiments are also envisioned.

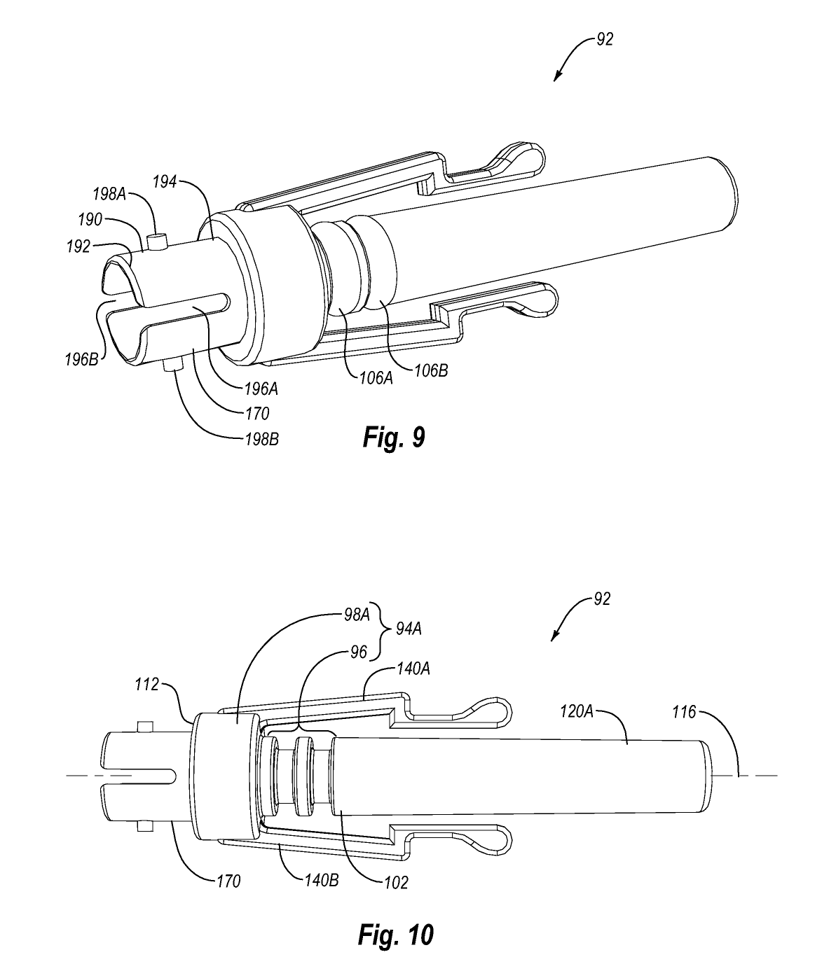

As previously discussed with regard to FIG. 2, plug fitting 90 or sensor fitting 92 can be received within ports 52. Depicted in FIG. 9 is a perspective view of one embodiment of sensor fitting 92. Sensor fitting 92 and plug fitting 90 have common structural elements. As such, like structural elements between senor fitting 92 and plug fitting 90 will be identified by like reference characters. Specifically, with reference to FIG. 10, sensor fitting 92 comprises a plug 94A which includes stem 96 having an end cap 98A attached thereto. Opposing arms 140A and 140B project from end cap 90A. As will be discussed below in great detail, a guide 120A projects from second end 102 of stem 96 while a connector 170 projects from outside face 112 of end cap 98A.

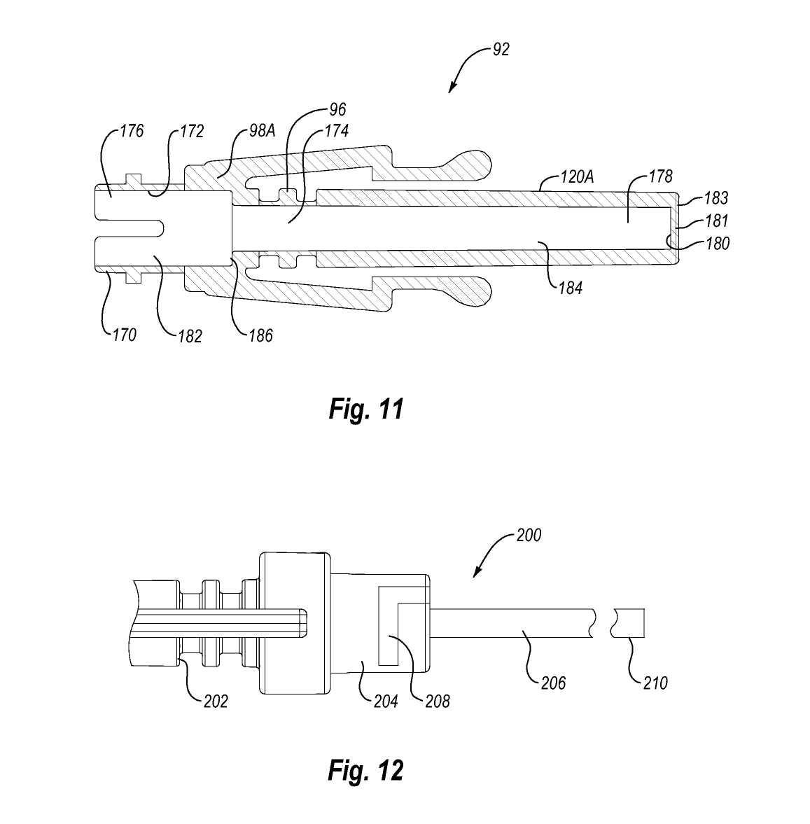

As depicted in FIG. 11, guide 120A has a substantially cylindrical configuration and terminates at an end wall 180. End wall 180 has a terminal end face 181 on which an optical sensor 183, as will be discussed below, is disposed. As with guide 120, guide 120A is configured to both guide the placement of stem 96 and occupy the volume of passageway 56 of port 52. Sensor fitting 92 also has an interior surface 172 that bounds a channel 174 having a first end 176 and an opposing second end 178. Channel 174 centrally extends through connector 170, end cap 98A, stem 96, and along guide 120 to end wall 180. Longitudinal axis 116 (FIG. 10) can centrally extend along channel 174. Here it is noted that end wall 180 is comprised of a material that is sufficiently transparent or translucent to enable light to pass from channel 174, through end wall 180 and onto optical sensor 183. End wall 180 is also made of material that will permit that attachment of optical sensor 183. Examples of materials that end wall 180 can be produced from include polycarbonate, high-density polyethylene (HDPE), polyethylene terephthalate (PET), copolyester and polyethylene. Other materials can also be used. It is appreciated that connector 170, end cap 98A, stem 96, and guide 120 are typically formed as a single, integral, unitary structure, such as by injection molding, and thus all these elements can be made from the above discussed materials.

Channel 174 is shown as having an enlarged portion 182 extending through connector 170 and a portion of end cap 98A and a constricted portion 184 that extends from end cap 98A to end wall 180. Enlarged portion 182 is shown as having a larger transverse cross sectional area or diameter than the transverse cross sectional area or diameter of constricted portion 184. As such, an annular shoulder 186 inwardly projects from enlarged portion 182 to constricted portion 184.

Connector 170 can come in a variety of different configurations and is simply designed to removeably couple with a fiber optic cable. For example, connector 170 can be configuration as a conventional BNC connector, threaded connector, press-fit connector or other conventional connectors. As depicted in FIG. 9, connector 170 can comprise a tubular sleeve 190 have a first end 192 and opposing second end 194. Slots 196A and B longitudinally extend along sleeve 190 from first end 192 toward second end 194. A pair of prongs 198A and B outwardly project from the exterior surface of sleeve 190 at locations 90° from slots 196A and B. Slots 196 and prongs 198 are used for removably coupling with a fiber optic cable. For example, depicted in FIG. 12 is one example of a fiber optic cable 200. Cable 200 includes a cable sheath 202, a connector 204 disposed at the end of cable sheath 202, and one or more fiber optic lines 206 that are housed within sheath 202 and openly project out through connector 204. Fiber optic lines 206 terminate at a terminal end 210. Connector 204 can have opposing L-shape slots 208 for receiving and removably engaging prongs 198A and B.

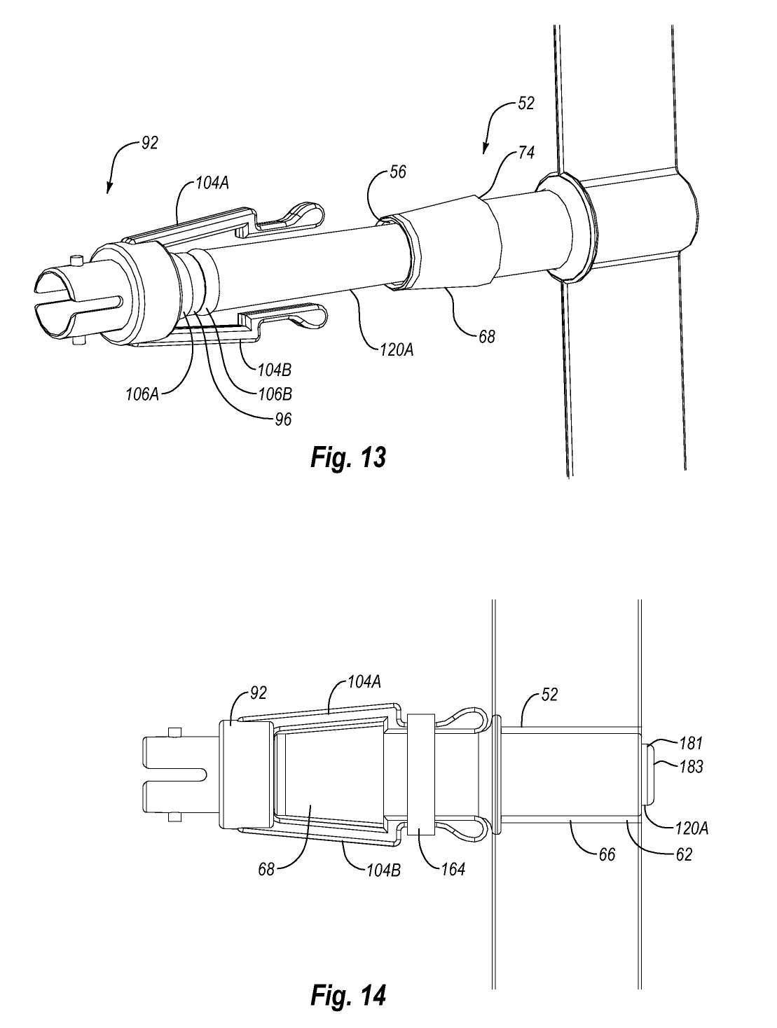

Turning to FIG. 13, sensor fitting 92 is coupled to port 52 in the same manner that plug 90 is coupled to port 52 as previously discussed. Specifically, guide 120A is received within passageway 56 of port 52 and is advanced until stem 96 is received within passageway 56. In this position, seals 106A and B form a liquid tight seal between stem 96 and port 52. As stem 96 is received within passageway 56, arms 104A and B expand over tip 68 and resiliently snap fit behind shoulder 74 so that sensor fitting 92 is removeably locked on port 52 as shown in FIG. 14. Tie 164 can then be secured over arms 104A and B to further secure sensor fitting 92 on port 52.

Either before or after sensor fitting 92 is coupled with port 52, fiber optic cable 200 can be removeably coupled with sensor fitting 92. Specifically, exposed fiber optic line 206 (FIG. 12) is inserted within the first end 176 of channel 174 (FIG. 11). Fiber optic cable 200 is then advanced until connector 204 (FIG. 12) contacts and is coupled with connector 170. In this configuration, terminal end 210 of fiber optic line 206 is disposed adjacent to end wall 180. In the embodiment depicted in FIG. 14, terminal end face 181 of guide 120A projects beyond second end 66 of port 52 so that end face 181 and optical sensor 183 are disposed within compartment 40 of processing bag 22 (FIG. 2). In other embodiments, terminal end face 198 can be disposed at or within second end 66 of port 52.

In any embodiment, optical sensor 183 contacts the fluid within compartment 40 of processing bag 22 when in use. Optical sensor 183 is comprised of a material that changes its characteristics, such as its fluorescence, in response to change in the pH, dissolved oxygen, carbon dioxide, temperature, and other properties of the fluid that it is contacting. The characteristics or change in characteristics of optical sensor 183 can be measured by an apparatus coupled with fiber optic cable 200. More specifically, light is transmittal down fiber optic cable 200. The light passes though end wall 180 and shines onto optical sensor 183. In one embodiment, the light causes optical sensor 183 to fluoresce having fluorescence characteristics that are uniquely dependent on the pH, dissolved oxygen, carbon dioxide, temperature and/or other properties of the fluid that is contacting optical sensor 183. In turn, the fluorescent light shines back through end wall 180 and travels back through optical cable 200 where an apparatus processes the fluorescent light to determine and, if desired, output the determined fluid properties. Other types of optical sensors can also be used. Optical sensor 183, which can simply comprise a coating applied to end wall 180, and the apparatus for processing the returned signal are available from PreSens Precision Sensing GmbH. It is appreciated that different sensor fittings 92 can be used with different fiber optic cables 200 to measure different properties. Once processing of the fluid within processing bag 22 is complete, processing bag 22, sensor fittings 92 and plug fittings 90 can be disposed of while fiber optic cables 200 can be reused without the requirement for cleaning or sterilization.

It is appreciated that all of the alternative embodiments as discussed above with regard to plug fitting 90 are also applicable to sensor fitting 92. However, if guide 120A is eliminated, end wall 180 and optical sensor 183 would need to be moved to the end of stem 96. It is also appreciated that all of the benefits of plug fitting 90 are also applicable to sensor fitting 92. That is, sensor fitting 92 also functions as a plug fitting. Sensor fitting 92 also has other benefits. For example, sensor fitting 92 is relatively inexpensive to make and thus is disposable after use. Sensor fittings can be easily replaced or exchanged with other sensor fittings having different sizes or configuration depending on intended use or type of cable to be connected therewith. Sensor fitting 92 allows for a user to sense the conditions of the solution within processing bag 22 without the risk of contamination from sampling, aseptic connections, or conventional sensor probe installation.

Returning to FIG. 1, bag assembly 12 is typically produced by forming processing bag 22 as previously discussed and then attached port fittings 90 and/or sensor fittings to each of barb ports 52. Each of tube ports 44 are also closed by either attaching a closed line, cap, plug fitting 90, sensor fitting 92 or some other sealing mechanism. With compartment 40 (FIG. 2) of bag assembly 12 sealed closed, the entire bag assembly 12 is sterilized such as by radiation or other conventional techniques.

Bag assembly 12 has a number of unique benefits over conventional rocker bags. For example, in some conventional rocker bags, the sensors are mounted on the bottom wall of the bag so as to be disposed against the rocker platform. This assembly typically requires the cable connected to the sensors to extend down through the rocker platform and around the rocking mechanism. Such assemblies are complex, cumbersome to couple together and potentially expose the cable to moving parts that can damage the cable.

In bag assembly 12, sensor fittings 92 are disposed at the side seam of processing bag 22. This makes it easy to access sensor fittings 92, couple cables thereto, organize the cables, and keep the cables away from moving parts. This configuration also helps ensures that sensor fittings 92 are centrally located within the fluid independent of the fluid level. In addition to the foregoing, because processing bag 22, in the depicted embodiment, is a pillow-type bag with ports 52 being disposed at the seam thereof, bag assembly 12 forms a natural drain to ports 52 when bag assembly 12 is hung or otherwise supported with ports 52 in the downward direction. This is in contrast to trying to drain bag assembly 12 through tube ports 44 where there is no natural draining towards those ports.

Furthermore, as previously discussed, because of their unique configuration, plug fittings 90 and sensors fittings 92 can be made of a variety of different materials. As such, there is a greater overall variety of materials for which bag assembly 12 can be made. For example, it is appreciated that each of plug fittings 90, sensor fittings 92, barbed ports 52, tube ports 44, and the fluid contact surface of processing bag 22 can all be made of the same material so as to limit the different number of materials that the fluid contacts. For example, the above elements can all be made of polyethylene.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A port fitting comprising:
a plug having a first end and an opposing second end with an axis extending through the opposing ends;
an O-ring disposed on and encircling the plug; and
an elongated first arm that projects alongside the length of the plug, the first arm having a first end secured to the first end of the plug and an opposing second end that is freely disposed so that the first arm can be flexed by manipulation of the second end, the first arm having a catch that inwardly projects toward to the axis of the plug.

2. The port fitting as recited in claim 1, further comprising a second arm spaced apart from the first arm that projects alongside the length of the plug, the second arm having a first end secured to the first end of the plug and an opposing second end that is freely disposed so that the second arm can be flexed by manipulation of the second end, the second arm having a catch that inwardly projects toward to the axis of the plug.

3. The port fitting as recited in claim 1, wherein the plug and the first arm are comprised of polypropylene, high-density polyethylene (HDPE), polycarbonate, polyvinylidene fluoride (PVDF), or polyethylene terephthalate (PET).

4. The port fitting as recited in claim 1, further comprising an elongated guide projecting from the second end of the plug along the axis of the plug.

5. The port fitting as recited in claim 1, further comprising:
the guide having a first end secured to the second end of the plug and an opposing second end, the second end terminating at an end wall; and
the plug and guide bounding a channel extending from the first end of the plug to the end wall of the guide.

6. The port fitting as recited in claim 5, further comprising an optical sensor disposed on the end wall of the guide.

7. The port fitting as recited in claim 5, further comprising a connector secured to the first end of the plug, the connector having an opening extending therethrough that communicates with the channel in the plug and guide.

8. The port fitting as recited in claim 1, further comprising an annular groove formed on and encircling the plug, the o-ring being disposed within the annular groove.

9. The port fitting as recited in claim 1, wherein the plug comprises:
a stem having a first end and an opposing second end, the stem having a transverse cross section with a diameter; and
a cap mounted on the first end of the stem, the cap having a transverse cross section with a diameter that is larger than the diameter of the stem, the first end of the first arm being secured to the cap.

10. A port assembly comprising:
a barbed port having an interior surface that bounds a passageway extending therethrough, the barbed port comprising:
a tubular stem; and
a tubular tip projecting from the stem, the tip having frustoconical outside face and an annular shoulder that projects from the tubular stem to the outside face; and
a port fitting comprising:
a plug having a first end and an opposing second end with an axis extending through the opposing ends; and
an elongated first arm that is connected to the plug and has an inwardly projecting catch, the plug being received within the passageway of the barbed port so that the catch on the first arm is passed over the outside face of the tip and disposed adjacent to the annular shoulder of the barbed port.

11. The port assembly as recited in claim 10, wherein a liquid tight seal is formed between plug and the interior surface of the barbed port.

12. The port assembly as recited in claim 10, further comprising an o-ring disposed on and encircling the plug, the o-ring engaging the interior surface of the barbed port to form the liquid tight seal.

13. The port assembly as recited in claim 10, further comprising an elongated second arm connected to the plug at a location spaced apart from the first plug, the second arm having an inwardly projecting catch disposed adjacent to the annular shoulder of the barbed port.

14. The port assembly as recited in claim 13, further comprising a tie that passes over a portion of the first arm and the second arm and encircles the barbed port.

15. The port assembly as recited in claim 14, wherein the first arm has a shoulder and an enlarged head formed thereon, the tie being disposed between the shoulder and enlarged head.

16. The port assembly as recited in claim 10, further comprising an elongated guide projecting from the second end of the plug along the axis of the plug.

17. The port assembly as recited in claim 16, further comprising:
the guide having a first end secured to the second end of the plug and an opposing second end, the second end of the guide terminating at an end wall; and
the plug and guide bounding a channel extending from the first end of the plug to the end wall of the guide.

18. The port assembly as recited in claim 17, further comprising an optical sensor disposed on the end wall of the guide, the end wall being transparent or translucent.

19. The port assembly as recited in claim 18, further comprising a connector secured to the first end of the plug, the connector having an opening extending therethrough that communicates with the channel in the plug and guide.

20. The port assembly as recited in claim 19, further comprising a fiber optic cable removably secured to the connector, a portion of the fiber optic cable being disposed within the channel of the guide so that the fiber optic cable can shine light on the end wall.

21. A method for using a port fitting comprising:
inserting a guide of a port fitting into a passageway of a barbed port, the barbed port having an outwardly flaring frustoconical tip that terminates at an inwardly projecting shoulder; and
advancing the guide into the passageway so that a pair of spaced apart arms of the port fitting progressively outwardly flex as they travel along the tip of the barbed port and then resiliently inwardly rebounding so that a catch formed on each arm is disposed adjacent to the shoulder of the barbered port.

22. The method as recited in claim 21, wherein the guide is advanced into the passageway until a plug mounted on the end of the guide is received within the passageway, a liquid tight seal being formed between the plug and the barbed port.

23. The method as recited in claim 22, wherein the liquid tight seal is formed by an o-ring encircling the plug and biasing against an interior surface of the barbed port.

24. The method as recited in claim 21, further comprising passing a tie over a portion of the first arm and the second arm so that the tie encircles the barbed port.

25. The method as recited in claim 21, further comprising coupling an optical cable to the port fitting so that a portion of the optical cable passes down a channel that extends through the plug and a portion of the guide, the channel terminating at an end wall formed at and end of the guide, the end wall being transparent or translucent and having an optical sensor disposed thereon.

26. The method as recited in claim 21, further comprising:
outwardly flexing the pair of spaced apart arms so that the catches are separated from the barbed port; and
removing the port fitting from within the passageway of a barbed port.

27. A bioreactor bag assembly comprising:
a flexible, pillow-type processing bag comprised of a bottom wall and an overlying top wall that are both comprised of a flexible polymeric sheet, a least a portion of a perimeter edge of the top wall being sealed to a perimeter edge of the bottom wall so that the top wall and bottom wall bound a sterile compartment therebetween;
a barbed port having an interior surface that bounds a passageway extending therethrough, the barbed port comprising:
a tubular stem, at least a portion of the tubular stem being secured between the top wall and the bottom wall of the processing bag so that the passageway communicates with the sterile compartment; and
a tubular tip projecting from the stem outside of the sterile compartment, the tip having an outwardly flaring frustoconical outside face that terminates at an inwardly projecting shoulder;
a port fitting removably received within passageway of the barbed port so as seal the passageway closed; and
a fiber optic cable removably coupled with the port fitting.

28. The bioreactor bag assembly as recited in claim 27, further comprising a rocker table on which the bottom wall of the processing bag rests, the rocker table being configured to rock the processing bag back and forth.
